(19) United States
(12) Patent Application Publication
(10) Pub. No.: US 2019/0079492 A1
(43) Pub. Date: Mar. 14, 2019

(54) APPARATUS AND METHODS FOR ADDITIVELY MANUFACTURING LATTICE STRUCTURES

(71) Applicant: DIVERGENT TECHNOLOGIES, INC., Los Angeles, CA (US)

(72) Inventors: Thomas Samuel BOWDEN, JR., Los Angeles, CA (US); Muhammad Faizan ZAFAR, Long Beacha, CA (US); Ross Harrison BYERS, Manhattan Beach, CA (US); Narender Shankar LAKSHMAN, Torrance, CA (US); Broc William TenHOUTEN, Rancho Palos Verdes, CA (US); Richard Winston HOYLE, Clarkston, MI (US); Antonio Bernerd MARTINEZ, El Segundo, CA (US)

(21) Appl. No.: 15/705,123

(22) Filed: Sep. 14, 2017

(51) Int. Cl. G05B 19/4099; B33Y 50/02; B33Y 80/00

(52) U.S. Cl. CPC G05B 19/4099; B22F 3/1055; B33Y 80/00; B33Y 50/02

(57) ABSTRACT

Apparatus and methods for additively manufacturing lattice structures are disclosed herein. Lattice structures are analyzed and automatedly generated with respect to surface proximity. A lattice structure is varied by changing lattice element variables including lattice density. An automated approach using CAD algorithms or programs can generate data for lattice structures based on design variables including volume, surface, angle, and position.

### BACKGROUND

### Field

The present disclosure relates generally to the additive manufacturing of lattice structures, and more specifically to the additive manufacturing of lattice structures in transport vehicles.

### Background

Recently three-dimensional (3D) printing, also referred to as additive manufacturing (AM), has presented new opportunities to efficiently build automobiles and other transport structures such as airplanes, boats, motorcycles, and the like. Applying AM processes to industries that produce these products has proven to produce a structurally more efficient transport structure. An automobile produced using 3D printed components can be made stronger, lighter, and consequently, more fuel efficient. Advantageously, AM, as compared to traditional manufacturing processes, does not significantly contribute to the burning of fossil fuels; therefore, AM can be classified as a green technology.

Numerous AM technologies exist. In many of these technologies, the 3D printer uses a laser or other energy source to fuse metallic powder into complex metal parts. During this process, periodic lattice structures and temporary support structures may be used. Periodic lattice structures are formed to reduce mass while maintaining structural integrity; and temporary support structures may be required to provide structural support during the build, such as to provide support for curved or overhanging areas of the structure being printed. However, for a variety of reasons traditional 3D printing methods for generating periodically arranged lattice supports may waste material. Accordingly, there is a need to discover and develop new ways to additively manufacture lattice structures.

### SUMMARY

Several aspects of additively manufacturing lattice structures will be described more fully hereinafter with reference to three-dimensional (3D) printing techniques.

In one aspect a method for additively manufacturing a component comprises receiving a model of the component to be additively manufactured, identifying one or more regions of the component requiring structural support, and automatedly generating at least one self-supporting lattice network in the identified one or more regions to produce a modified model.

The at least one self-supporting lattice network can comprise a permanent part of the component. Also, the at least one self-supporting lattice network can be removable after the component is additively manufactured.

The automatedly generating the at least one self-supporting lattice network can comprise generating lattice elements. The lattice elements can have different densities. The lattice elements having different lengths; and the lattice elements can have different cross-sectional areas.

The automatedly generating the at least one self-supporting lattice network can comprise generating a plurality of levels of lattice elements, each level can have a different number of lattice elements.

The automatedly generating the at least one self-supporting lattice network can further comprise generating a plurality of lattice elements having substantially conical-shaped ends. An angle associated with one or more of the conical-shaped ends can be determined to enable the lattice network to be self-supporting. The conical shaped ends can each comprise a hollow section, and an interior of the hollow section can comprise a plurality of smaller lattice elements having correspondingly smaller substantially conical-shaped ends.

The automatedly generating the at least one self-supporting lattice network can comprise generating a hierarchy of ascending levels of lattice elements beginning at a base level and ending at a last level. The last level can contact the identified one or more regions. Also, the lattice elements in each of the ascending levels can have progressively smaller conical-shaped ends for coupling to progressively smaller lattice elements of the next ascending level.

The method for generating the lattice network can further comprise generating the at least one self-supporting lattice network at an orientation substantially normal to a plane of the one or more regions. The lattice network can comprise a custom honeycomb structure.

The automatedly generating the at least one self-supporting lattice network can comprise generating lattice elements. The lattice elements can be oriented at or lower than an angle determined to maintain self-support. The lattice elements can also be curved.

In another aspect an apparatus for additively manufacturing a component is configured to receive a model of a component to be additively manufactured, to identify one or more regions of the component requiring structural support, and to automatedly generate at least one self-supporting lattice network in the identified one or more regions.

The at least one self-supporting lattice network can comprise a permanent part of the component. The at least one self-supporting lattice network can be removable after the structure is additively manufactured.

The at least one self-supporting lattice network can comprise generating lattice elements. The lattice elements can have different densities. The lattice elements can have different lengths; and the lattice elements can have different cross-sectional areas.

The at least one self-supporting lattice network can comprise a plurality of levels of lattice elements. Each level can have a different number of lattice elements.

The at least one self-supporting lattice network can further comprise a plurality of lattice elements having substantially conical-shaped ends. An angle associated with one or more of the substantially conical-shaped ends can be determined to enable the corresponding lattice network to be self-supporting. The substantially conical shaped ends can each comprise a hollow section; and an interior of the hollow section can comprise a plurality of smaller lattice elements having correspondingly smaller substantially conical-shaped ends.

The at least one self-supporting lattice network can comprise lattice elements which are oriented at or lower than a predetermined angle determined to maintain self-support. The at least one self-supporting lattice network can comprise a plurality of lattice elements. One or more of the plurality of lattice elements can be curved.

In another aspect an additively manufactured component comprises at least one region structurally supported by a lattice network. The lattice network has a hierarchy of ascending levels of lattice elements from a base level to a final level contacting the at least one region. The lattice elements in each ascending level terminate in progressively smaller substantially conical-shaped ends configured to couple to lattice elements of a next ascending level.

An interior of the conical shaped ends of at least one level can be coupled to a plurality of lattice elements of a next ascending level. An angle of the conical-shaped ends can be determined such that the lattice network is self-supporting. Each ascending level can have a greater number of lattice elements than a preceding level. A density of the lattice elements of each ascending level can be lower than a density of the lattice elements of the preceding level. Also, a cross-sectional area of the lattice elements of each ascending level can be lower than a cross-sectional area of the lattice elements of the preceding level.

Different composite materials may be used that were not previously available in traditional manufacturing processes. It will be understood that other aspects of additively manufactured lattice structures will become readily apparent to those skilled in the art from the following detailed description, wherein it is shown and described only several embodiments by way of illustration. As will be appreciated by those skilled in the art, additively manufactured lattice structures can be realized with other embodiments without departing from the invention. Accordingly, the drawings and detailed description are to be regarded as illustrative in nature and not as restrictive.

### BRIEF DESCRIPTION OF THE DRAWINGS

Various aspects of apparatus and methods for generating lattices and support structures with the aid of CAD algorithms will now be presented in the detailed description by way of example, and not by way of limitation, in the accompanying drawings, wherein:

FIG. 1 illustrates an additively manufactured lattice at a surface according to an embodiment.

FIG. 2 illustrates a panel constructed with an additively manufactured lattice according to another embodiment.

FIG. 3A illustrates an additively manufactured lattice at a surface according to an embodiment.

FIG. 3B illustrates a lattice element at a surface interface according to an embodiment.

FIG. 3C illustrates a cross section of the lattice element of FIG. 3B.

FIG. 3D illustrates a lattice element for attaching at a surface interface according to another embodiment.

FIG. 4A illustrates a lattice connection according to an embodiment.

FIG. 4B illustrates a lattice connection according to another embodiment.

FIG. 5A illustrates a high-level system architecture of an apparatus for additively manufacturing a component according to an embodiment.

FIG. 5B illustrates a high-level system architecture including an apparatus for additively manufacturing a component according to another embodiment.

FIG. 6A conceptually illustrates a process for additively manufacturing a lattice structure according to an embodiment.

FIG. 6B conceptually illustrates a sub-process for additively manufacturing a lattice structure according to the embodiment of FIG. 6A.

FIG. 6C conceptually illustrates another sub-process for additively manufacturing a lattice structure according to the embodiment of FIG. 6A.

### DETAILED DESCRIPTION

The detailed description set forth below in connection with the drawings is intended to provide a description of exemplary embodiments of manufacturing lattice structures using additively manufacturing techniques, and it is not intended to represent the only embodiments in which the invention may be practiced. The term “exemplary” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the invention to those skilled in the art. However, the invention may be practiced without these specific details. In some instances, well-known structures and components may be shown in block diagram form, or omitted entirely, in order to avoid obscuring the various concepts presented throughout this disclosure.

An advantage of additive manufacturing (AM) compared to traditional manufacturing methods is the ability to produce parts with complex geometries. For instance, parts can be printed that incorporate a strong lattice structure instead of solid mass, thereby reducing overall material consumption. Lattice structures can thus reduce mass while maintaining structural integrity, and various lattice structures may be used to ensure a structurally efficient material distribution.

Lattice structures are formed as repeating or periodic patterns of mechanical structures or elements which can provide structural integrity to hollow parts. These structures can be used to reduce the mass of the final part while also reducing material consumption during the 3D printing process. However, previous design and manufacturing approaches to rendering parts with lattice structures oftentimes can waste materials by producing too much lattice structure or by selecting erroneous values for various applicable lattice element characteristics, including lattice density and lattice element length, that result in unusable parts or wasted material. Accordingly, there is a need to overcome the limitations of current lattice generating applications and AM technologies.

Apparatus and methods for additively manufacturing lattice structures are disclosed herein. Lattice structures are analyzed and automatedly generated with respect to surface proximity. A lattice structure is varied by changing lattice element variables including lattice density. An automated approach using CAD algorithms or programs can generate data for lattice structures based on design variables including volume, surface, angle, and position. Support structures can be designed for temporary placement. Thereafter, techniques including electromagnetic field inducement can be used to break temporary support structures.

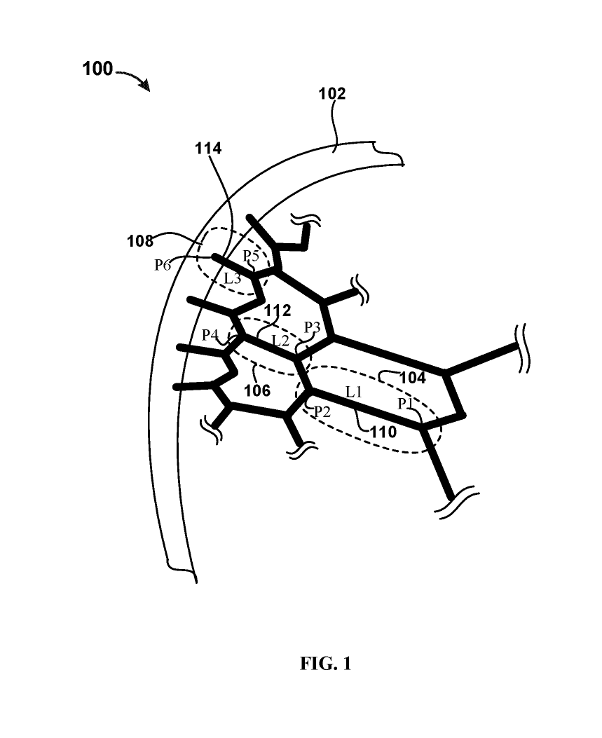

A problem associated with AM parts can be the unnecessary repetition of fixed lattice patterns having a fixed density. Lattice structures currently generated for parts often follow the same repetitive pattern with the same density. This can lead to higher material consumption and increased complexity, which can further cascade into failure during 3D printing. The AM lattice 100 of FIG. 1 illustrates a way to address this problem.

FIG. 1 illustrates an AM lattice 100 at a surface 102 according to an embodiment. The AM lattice 100 includes lattice sections 104, 106, and 108, which can also be referred to as lattice substructures. The lattice section 104 includes a lattice element 110 of length L1 extending between lattice connection nodes P1 and P2. The lattice section 106, encompassing a region closer to the surface 102, includes a lattice element 112 of length L2 extending between lattice connection nodes P3 and P4; and the lattice section 108, encompassing a region closest to and making contact with the surface 102, includes a lattice element 114 of length L3 extending between lattice connection node P5 and the surface at interface node P6.

The additively manufactured lattice 100 can address wasteful unnecessary repetition of fixed lattice patterns by using lattice branching. Lattice branching can vary lattice density as a function of surface proximity, and one method for varying lattice density can be to vary lattice element length. For instance, as shown in FIG. 1, long wire-like structures, such as lattice element 110, emerge from a central region away from the surface 102. Lattice elements then branch out into shorter, more dense lattice structures towards the surface 102. By way of example, lattice element 114, which is in contact with the surface 102 at interface node P6, has a relatively short length L3, compared to the lengths L2 and L1, thereby providing a relatively high lattice density near the surface 102. In contrast, lattice element 110 has a relatively long element length L1 compared to the lengths L2 and L3, thereby providing a lower lattice density away from the surface 102.

Having a higher packing or lattice density near the surface 102, the additively manufactured lattice 100 can improve the structural integrity of the associated component, and can be especially beneficial for load bearing. In this way, a lattice may be generated as a function of location so that more lattice may be used where structurally desired, and less lattice may be used where it is deemed less beneficial. Thus, compared to lattices generated using current lattice density generation techniques, a lattice generated using lattice branching can offer reduced material usage, which in turn, can advantageously reduce the overall weight of the resulting AM structures. For an additively manufactured panel, for instance, lattice branching can beneficially improve panel strength while availing a lighter panel design.

In an embodiment, lattice branching can be implemented with an algorithm or set of algorithms included in a computer aided design (CAD) program. A computer aided design program can be implemented on a computer or computer system, which in turn can be connected to a 3D printer. A CAD program or algorithm can advantageously vary characteristics of elements, such as length and width of elements 110, 112, and 114 so as to improve material usage.

In some embodiments, a CAD program or algorithm can first create data for substructures (lattice elements) which can be buildable at angles. The CAD algorithm can next calculate the locations of where lattice branching needs to be implemented by taking into account boundary conditions or constraints. For instance, for a perpendicular section, where components of forces (e.g. gravity) may necessitate a need for increased support, a CAD algorithm can generate lattices to support the perpendicular region, while in smooth flat regions, where components of forces may not necessitate a need for increased support, a CAD algorithm can exclude lattice elements. Examples of regions requiring increased support can include overhangs, while examples of regions having smooth flat surfaces can include exterior panel surfaces.

In other embodiments, lattice branching can be applied to complex lattice structures. For instance, lattice branching can be applied to honeycomb lattices, which are useful for the additive manufacturing of panels. Honeycomb lattices or structures are structures with minimal material and weight that can offer superior mechanical properties. The conventional approaches to manufacturing honeycomb structures can require expensive and inflexible tooling. Moreover, conventional techniques can be limited to producing honeycomb structures with certain geometrical constraints. For instance, conventional processes can be limited to producing only hexagonal honeycomb structures.

Using CAD algorithms to produce 3D-printed lattice structures can advantageously avail custom honeycomb structures with custom lattice structures. By generating complex lattice structures between surfaces, parts with greater mechanical support properties can be realized. For instance, sandwich panels produced using honeycomb structures can be made lightweight and strong. Additionally, by orienting a lattice direction with the aid of a CAD algorithm, panel support properties can be designed with precision to follow different carefully selected axes. Also, lattices can be designed to branch out in directions where they are specifically needed, much like in a fiber reinforced composite.

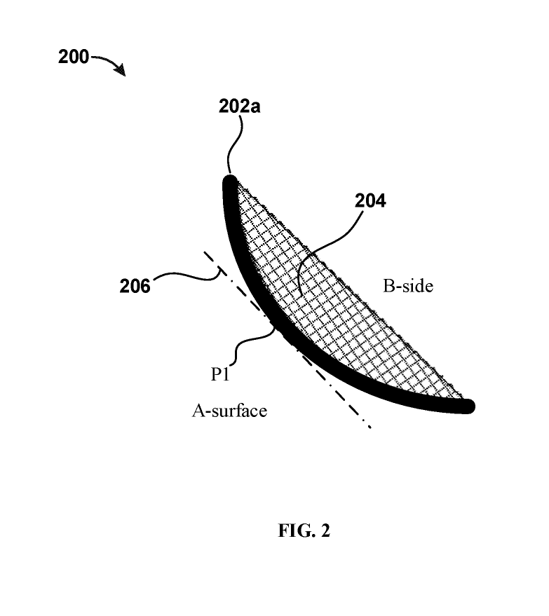

FIG. 2 illustrates a panel 200 constructed with an additively manufactured lattice 204 according to another embodiment. The panel 200 has an A-surface tangent at a point P1 and a B-side surface where a lattice region 204 is generated. The lattice region 204 can be generated by a CAD algorithm using lattice branching as described above. Additionally, the A-surface can be a smooth surface satisfying Class-A requirements for automotive panels. The lattice region 204 of the B-side surface can comprise dense lattice structures, imparting additional structural characteristics to the panel as needed.

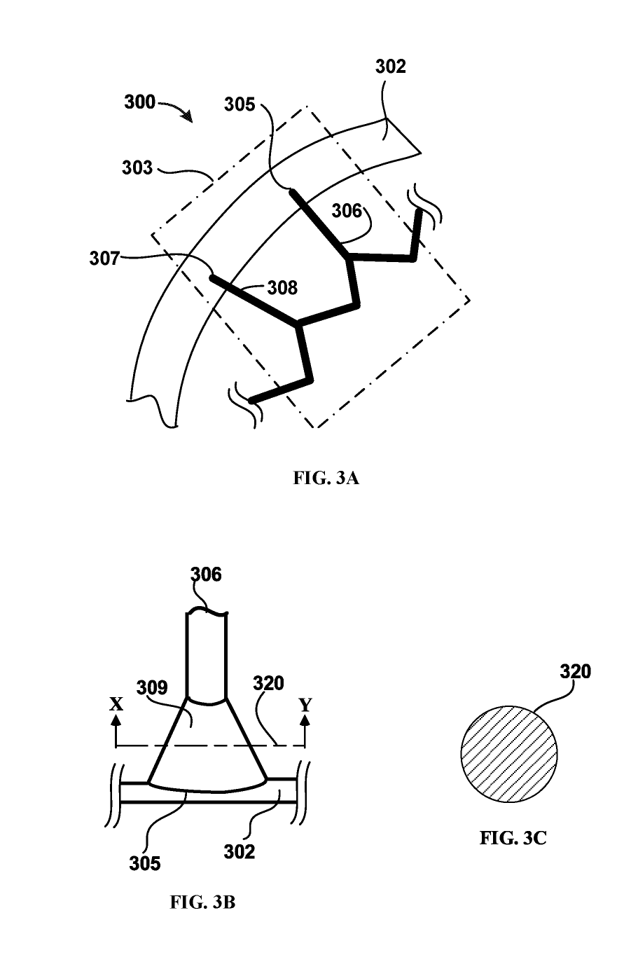

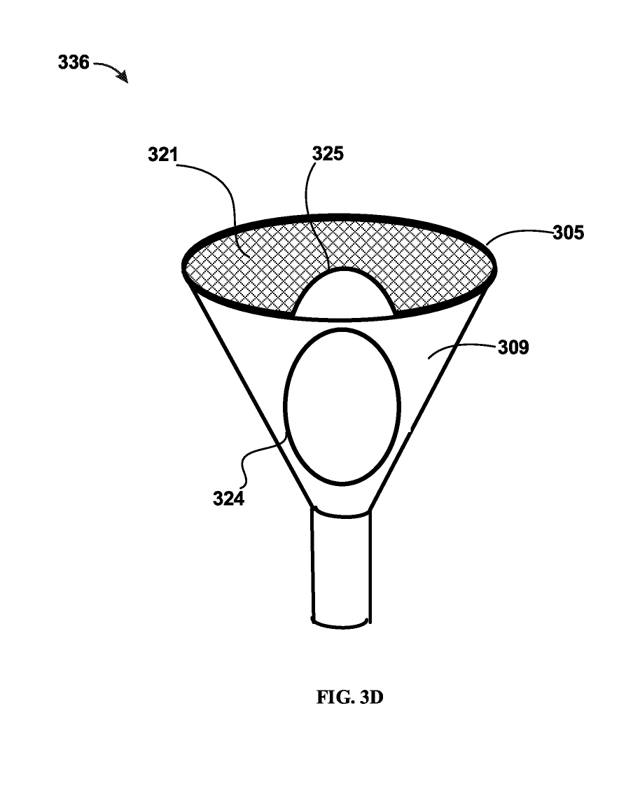

FIG. 3A illustrates an additively manufactured lattice 300 at a surface 302 according to an embodiment. A periodic region 303 of the lattice 300 includes lattice elements 306 and 308 which can serve as beams and can also be referred to as surface beams. Lattice element 306 connects to the surface 302 at an intersection or interface 305 while lattice element 308 connects to the surface 302 at an intersection or interface 307. In order to reduce stress at the intersections (interfaces) 305 and 307 and to improve post manufacturing powder removal, the lattice elements 306 and 308 can be manufactured with a conical or funnel shape as shown in FIG. 3B.

FIG. 3B illustrates a lattice element 306 at a surface interface 305 according to an embodiment. The lattice element 306 can also function as a beam which connects to the surface 302 at the surface interface (intersection) 305. As shown in FIG. 3B, the lattice element 306 can have a tapered funnel or conical region 309. For illustrative purposes, a cross section 320 within the conical region 309 taken through a plane between points X and Y is illustrated in FIG. 3C.

FIG. 3C illustrates a cross section 320 of the lattice element of FIG. 3B. The cross section 320 is a cross-sectional part of the element (beam) 306 near the surface interface 305 and can be round or oval shaped as shown in FIG. 3C. In other embodiments, the cross section 320 associated with region 309 can take on other shapes, and can be oblong, elliptical, etc. By having a conical region 309 close to the surface 302, the lattice element 306 can function as a beam with lower stresses as compared to an element or beam which does not have a conical region 309. More specifically, a gradual change in surface area of conical region 309 can result in smooth transitions in stress concentrations and can allow forces to be more evenly and gradually distributed. In this way stress is advantageously reduced while structural integrity is preserved or enhanced. Also, in an exemplary embodiment, the conical section 309 can be additively manufactured to be hollow or substantially hollow. This embodiment may, in appropriate instances, enable the AM structure to retain its strength and structural integrity while minimizing the weight of the structure and saving on materials.

Additionally, having the funnel or conical region 309 can advantageously facilitate residual powder removal. After 3D printing, powder residue can remain or get trapped at interfaces such as interface 305; and removing powder after manufacturing can become problematic. Having a tapered conical region 309 can reduce powder trapping by reducing sharp edges and corners at the interface 305. Additionally, having a tapered conical region 309 can avail a greater pitch distance, the distance between two lattice elements on a surface; this in turn can effectively produce smoother or larger pockets for powder confinement. Larger pockets can, in turn, facilitate powder removal.

FIG. 3D illustrates a lattice element 336 for attaching at a surface interface 305 according to another embodiment. The lattice element 336 is similar to the lattice element 306, except lattice element 336 is manufactured to have hollow sections 324 and 325. As shown in FIG. 3D, the lattice element 336 can have a hollow section 324 on one side and another hollow section 325 on another side of the conical region 309. The interior region 321 depicts locations where structures such as lattice elements are created during the additive manufacturing process. By having hollow sections 324 and 325, the amount of material required and the mass of the AM structure can be further reduced.

As discussed above, CAD algorithms can be used to generate data for locating lattice structures and surface elements. Additionally, CAD algorithms can be used to determine a beam or lattice element orientation. For instance, beam angle can be a factor in determining whether to generate support material. Complex lattice structures can consequently require support lattices if they are oriented at an angle (relative to some predetermined reference) exceeding a threshold angle. The threshold angle can be forty-five degrees with respect to a vertical reference; however, other values of threshold angle are possible. The threshold angle can depend on a variety of features, such as print material, print parameters and a span of overhanging structures.

A CAD algorithm can be implemented to make such determinations concerning the requisite threshold angle of beams or lattice elements so as to reduce the amount of support material required. In an embodiment, a CAD algorithm can automatedly generate lattice elements or beams for the AM structure in cases where the threshold angle between the beam or lattice and the relevant surface has not reached the threshold angle of 45 degrees. By using a build vector generated by a CAD algorithm, lattice elements in this example can automatically be oriented at a maximum of 45 degrees, thereby allowing for manufacturing a part with less support material.

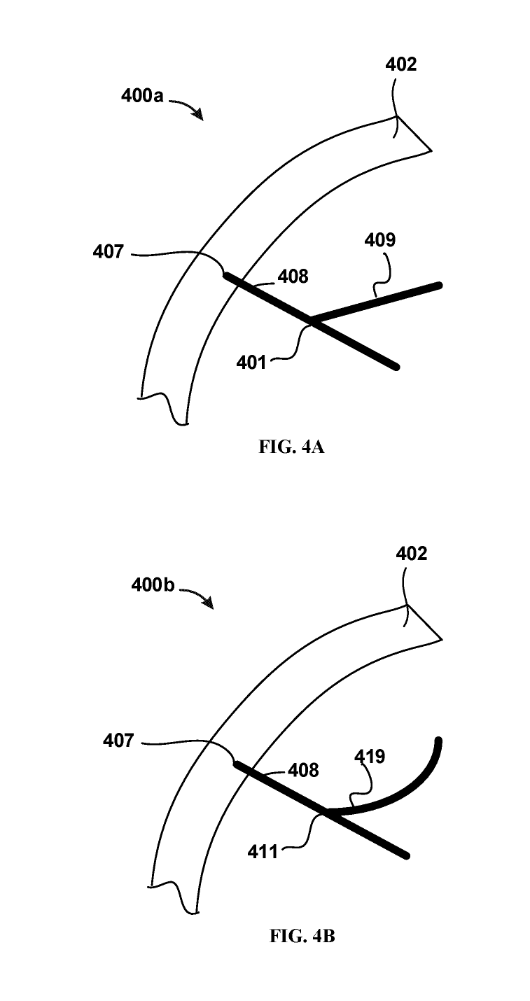

FIG. 4A illustrates a lattice connection 400a according to an embodiment. The lattice connection 400a has an element 408 attached to a surface 402 at an interface 407. The element 408 can be used as a beam support. Additionally, there is an element 409 connecting to element 408 at a branch connection node 401. The elements 408 and 409 can serve as beams or beam elements. The sharp corner at the branch connection node 401 can be classified as a structural discontinuity which can lead to trapped powder and can be a focal point for stress. A way to mitigate these problems is shown in FIG. 4B.

FIG. 4B illustrates a lattice element branch 400b according to another embodiment. The lattice element branch 400b is similar to lattice element branch 400a except there is a curved lattice element 419 attached to element 408 at a branch connection node 411. Having a curved lattice segment or element 419, the lattice element branch 400b can realize a structure with less stress than that of lattice element branch 400a. The curvature can organically reduce stress by reducing stress concentration. This can improve lattice structures employed in parts with more complex geometries. Additionally, this can reduce problems associated with powder trapping.

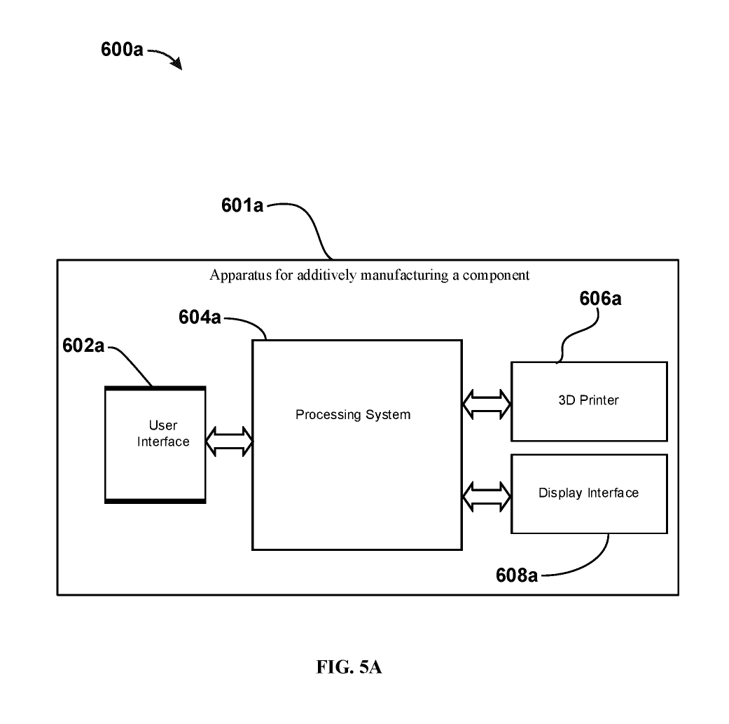

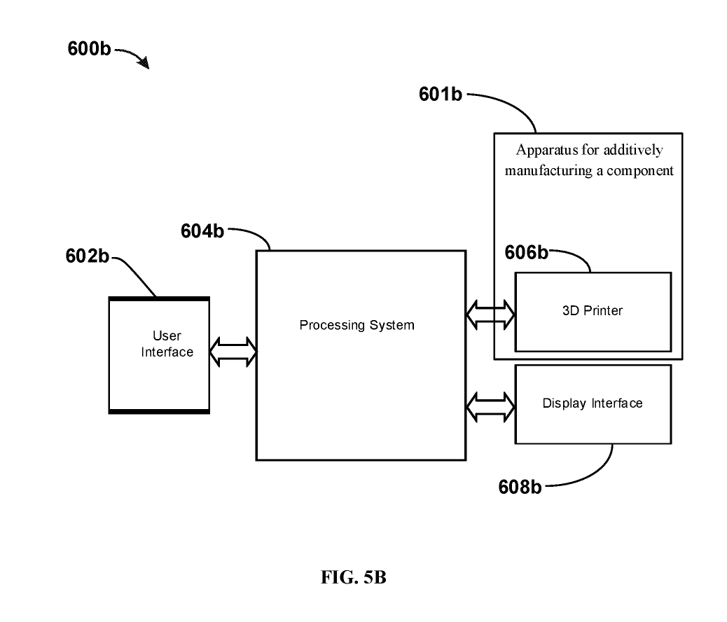

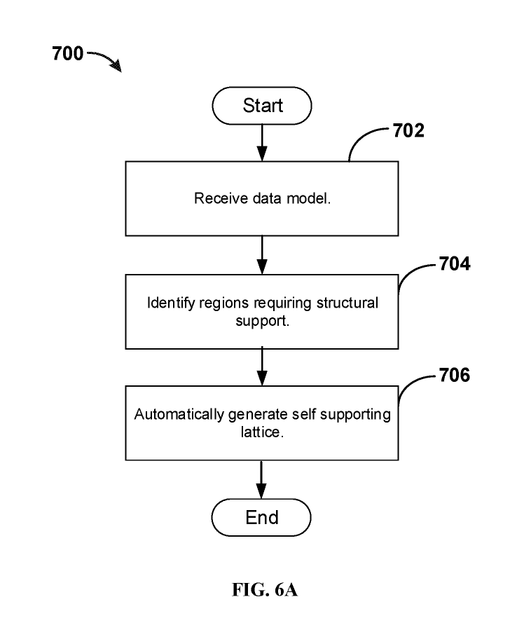

FIG. 5A illustrates a high-level system architecture 600a of an apparatus 601a for additively manufacturing a component according to an embodiment. The system architecture 600a shows the apparatus 601a as including a user interface 602a, a processing system 604a, a 3D printer 606a, and a display interface 608a. The user interface 602a can allow a user to interact with the processing system 604a and to input data or information relating to a structure or part for 3D printing. As shown in FIG. 5A, the processing system 604a can send data to the 3D printer 606a necessary for additively manufacturing a part using the 3D printer 606a. In addition, the processing system 604a can send information to the display interface 608a

The processing system 604a may also include machine-readable media, hard-drives, and/or memory for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

Examples of computer programs and instructions include programs for computer aided design (CAD) of additively manufactured parts. The processing system 604a can execute CAD programs for generating lattice data such as lattice branching data or surface lattice data relevant to embodiments described herein. A user can input information using the user interface 602a and review display data of structures for 3D printing on the display interface 608a. The processing system 604a can execute programs for automatedly generating lattice structure data, and the lattice structure data can be sent to the 3D printer 606a for printing structures having lattices and structures according to embodiments presented herein.

In addition to generating data for lattices and lattice branching, the computer system 604a can be used to execute CAD algorithms for determining where powder holes are printed during the additive manufacturing process. Powder holes can be strategically placed before 3D printing to facilitate powder removal from internal features. Currently, these holes necessitate manual entry into a CAD generated file of a part before additively manufacturing.

By using a CAD algorithm to automate the placement of powder holes, manufacturing time can advantageously be reduced. A CAD program or algorithm can determine powder hole sizes and locations. Hole size can be based on the size of powder particles. Additionally, the geometry of the holes can depend on the loading and boundary conditions specified for an additively manufactured part. Using a CAD algorithm for the placement of powder holes can advantageously eliminate or reduce the need for a complicated finite element analysis (FEA) presently used to determine loading stresses on an additively manufactured part.

A CAD algorithm may be used to design channels for powder transport within a part following a path of least resistance. Additionally, the CAD algorithm may determine paths for powder transfer from the inside region of a part to the outside for easy removal of trapped powder. The CAD algorithm or process can also strategically locate powder holes and powder transport paths to facilitate powder extraction with the assistance of gravity.

A CAD algorithm can be used to create aerodynamic contours and holes to drive a powder extraction process. After 3D printing, a post processing algorithm step may execute a procedure to drive air flow through aerodynamically designed contours to facilitate the removal of trapped powder.

A CAD algorithm can also take into account a number of variables to locate powder hole locations and transport paths. These variables may include powder material, powder size, average flow rate, and/or the speed of the powder; to name a few.

FIG. 5B illustrates a high-level system architecture 600b including an apparatus 601b for additively manufacturing a component according to another embodiment. The high-level system architecture 600b includes a user interface 602b, a processing system 604b, the apparatus 601b, and the display interface 608b. As shown in FIG. 5B, the apparatus 601b includes a 3D printer 606b.

The high-level system architecture 600b can be similar to the high-level system architecture 600a. For instance, the user interface 602b, the processing system 604b, the 3D printer 606b, and the display interface 608b can be similar to and perform similar functions as the user interface 602a, the processing system 604a, the 3D printer 606a, and the display interface 608a. However, unlike the apparatus 601a, which includes the user interface 602a, the processing system 604a, the 3D printer 606a, and the display interface 608a, the apparatus 601b excludes the user interface 602b, the processing system 604b, and the display interface 608b.

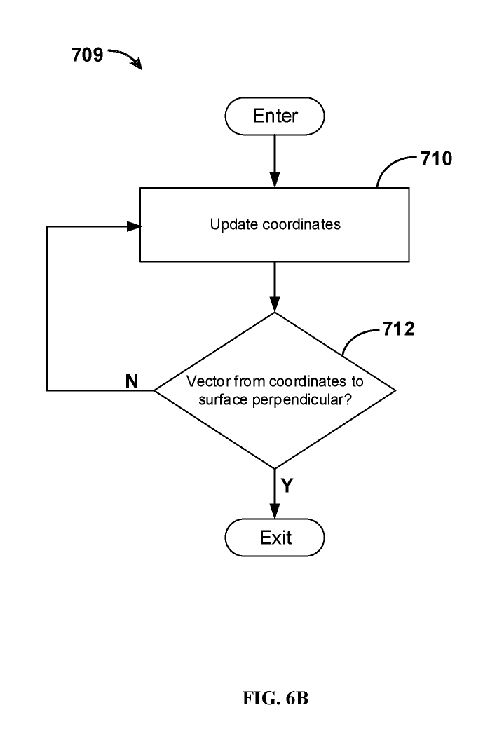

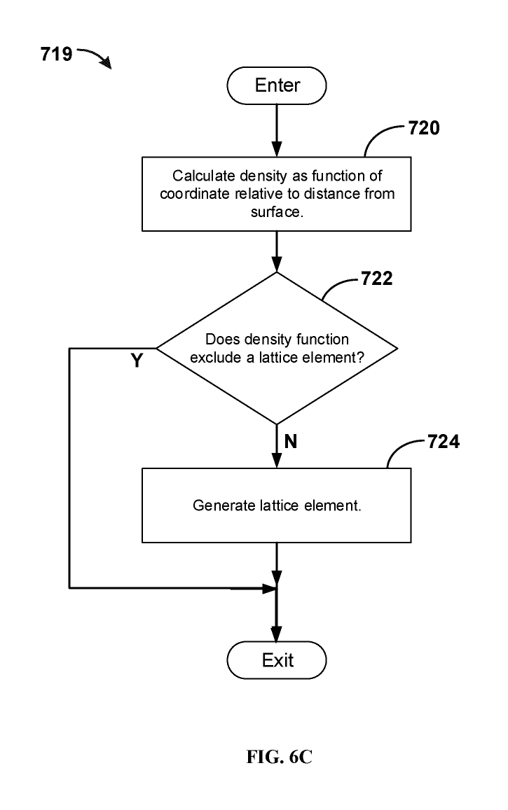

FIG. 6A conceptually illustrates a process for additively manufacturing a lattice structure according to an embodiment. In the first step 702 a data model is received. The data model can be generated or can be provided as input to a computer or hardware interface such as the interface 602a of FIG. 5A. In step 704 one or more regions of a component requiring structural support can be identified through use of a CAD algorithm or by manual entry from a user; and in step 706, based on the data, a CAD algorithm can be used to automatedly generate a self-supporting lattice network in the identified one or more regions determined by step 704. Automatedly generating a self-supporting lattice can include generating lattice data on a processor.

FIG. 6B conceptually illustrates a sub-process 709 for additively manufacturing a lattice structure according to the embodiment of FIG. 6A. The sub-process 709 includes a step 710 followed by a decision step 712, both of which can be used to mathematically determine a valid coordinate for a lattice segment. In an embodiment, a criterion can be that the segment be generated so that it is perpendicular to the surface of the structure being printed. Other criteria may be equally suitable in different embodiments.

In the step 710 the coordinates can be updated. Coordinates can be discretized in a Cartesian coordinate system or a non-Cartesian coordinate system such as a polar (angular) coordinate system. Updating can include additional steps such as adding an incremental delta quantity to a base number. The updated coordinates can then be used to determine a vector from the surface of the structure requiring support. In decision step 712 the vector can be analyzed with respect to its angle relative to the surface. If the angle is perpendicular, then the coordinates can be valid coordinates for creating a segment and the sub-process 709 exits with the valid coordinates; however, if the angle is not perpendicular, then the step 710 may be repeated to refresh and/or update the coordinates.

FIG. 6C conceptually illustrates another sub-process 719 for additively manufacturing a lattice structure according to the embodiment of FIG. 6A. The sub-process 719 includes a step 720 followed by a decision step 722 with a nested step 724, all of can be used to mathematically determine where and when lattice segments should be included and/or excluded. In this example, a criterion can be that segments are generated based on a density function. For instance, in some embodiments the density function can be used to validate coordinates for a large density of segments close to the surface of the structure and to validate (invalidate) coordinates for a lower density of segments further away from the surface of the structure. In other embodiments, different functions may be used for accomplishing lattice segment placement and corresponding location determination.

In the step 720 a density of segments can be calculated as a function of the location of the coordinate with respect to its distance from the surface of the structure. In decision step 722 the density value calculated in step 720 can be used to determine if the segment (or coordinate) should be excluded or should be generated based on the density function. If the density function in step 722 indicates that the segment should be excluded, say for instance in a less dense region, then the sub-process 709 exits without generating a lattice element or segment. However, if the density function in step 722 indicates that the segment should be included (not excluded) then the sub-process 709 proceeds to step 724 where it generates the lattice element (segment) prior to exiting.

The above sub-processes represent non-exhaustive examples of specific techniques to accomplish objectives described in this disclosure, It will be appreciated by those skilled in the art upon perusal of this disclosure that other sub-processes or techniques may be implemented that are equally suitable and that do not depart from the principles of this disclosure.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other techniques for additively manufacturing transport vehicles including automobiles, airplanes, boats, motorcycles, and the like.

Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A method for additively manufacturing a component comprising:
receiving a model of the component to be additively manufactured;
identifying one or more regions of the component requiring structural support; and
automatedly generating at least one self-supporting lattice network in the identified one or more regions to produce a modified model.

2. The method of claim 1, wherein the at least one self-supporting lattice network comprises a permanent part of the component.

3. The method of claim 1, wherein the at least one self-supporting lattice network is removable after the component is additively manufactured.

4. The method of claim 1, wherein the automatedly generating the at least one self-supporting lattice network comprises generating lattice elements having different densities.

5. The method of claim 1, wherein the automatedly generating the at least one self-supporting lattice network comprises generating lattice elements having different lengths.

6. The method of claim 1, wherein the automatedly generating the at least one self-supporting lattice network comprises generating lattice elements having different cross-sectional areas.

7. The method of claim 1, wherein the automatedly generating the at least one self-supporting lattice network comprises generating a plurality of levels of lattice elements, each level having a different number of lattice elements.

8. The method of claim 1, wherein the automatedly generating the at least one self-supporting lattice network further comprises generating a plurality of lattice elements having substantially conical-shaped ends.

9. The method of claim 8, wherein an angle associated with one or more of the conical-shaped ends is determined to enable the lattice network to be self-supporting.

10. The method of claim 8, wherein the conical shaped ends each comprise a hollow section, an interior of the hollow section comprising a plurality of smaller lattice elements having correspondingly smaller substantially conical-shaped ends.

11. The method of claim 1, wherein the automatedly generating the at least one self-supporting lattice network comprises generating a hierarchy of ascending levels of lattice elements beginning at a base level and ending at a last level contacting the identified one or more regions, the lattice elements in each of the ascending levels having progressively smaller conical-shaped ends for coupling to progressively smaller lattice elements of the next ascending level.

12. The method of claim 1, further comprising generating the at least one self-supporting lattice network at an orientation substantially normal to a plane of the one or more regions.

13. The method of claim 1, wherein the lattice network comprises a custom honeycomb structure.

14. The method of claim 1, wherein the automatedly generating the at least one self-supporting lattice network comprises generating lattice elements which are oriented at or lower than an angle determined to maintain self-support.

15. The method of claim 1, wherein the automatedly generating the at least one self-supporting lattice network comprises generating lattice elements which are curved.

16. An apparatus for additively manufacturing a component, the apparatus configured to:
receive a model of the component to be additively manufactured;
identify one or more regions of the component requiring structural support; and
automatedly generate at least one self-supporting lattice network in the identified one or more regions to produce a modified model.

17. The apparatus of claim 16, wherein the at least one self-supporting lattice network comprises a permanent part of the component.

18. The apparatus of claim 16, wherein the at least one self-supporting lattice network is removable after the structure is additively manufactured.

19. The apparatus of claim 16, wherein the automatedly generating the at least one self-supporting lattice network comprises generating lattice elements having different densities.

20. The apparatus of claim 16, wherein the at least one self-supporting lattice network comprises lattice elements having different lengths.

21. The apparatus of claim 16, wherein the at least one self-supporting lattice network comprises lattice elements having different cross-sectional areas.

22. The apparatus of claim 16, wherein the at least one self-supporting lattice network comprises a plurality of levels of lattice elements, each level having a different number of lattice elements.

23. The apparatus of claim 16, wherein the at least one self-supporting lattice network comprises a plurality of lattice elements having substantially conical-shaped ends.

24. The apparatus of claim 23, wherein an angle associated with one or more of the substantially conical-shaped ends is determined to enable the corresponding lattice network to be self-supporting.

25. The apparatus of claim 23, wherein the substantially conical shaped ends each comprise a hollow section, an interior of the hollow section comprising a plurality of smaller lattice elements having correspondingly smaller substantially conical-shaped ends.

26. The apparatus of claim 16, wherein the at least one self-supporting lattice network comprises lattice elements which are oriented at or lower than a predetermined angle determined to maintain self-support.

27. The apparatus of claim 16, wherein the at least one self-supporting lattice network comprises a plurality of lattice elements, and wherein one or more of the plurality of lattice elements are curved.

28. An additively manufactured component, comprising:
at least one region structurally supported by a lattice network having a hierarchy of ascending levels of lattice elements from a base level to a final level contacting the at least one region, the lattice elements in each ascending level terminating in progressively smaller substantially conical-shaped ends configured to couple to lattice elements of a next ascending level.

29. The component of claim 28, wherein an interior of the conical shaped ends of at least one level is coupled to a plurality of lattice elements of a next ascending level.

30. The component of claim 28, wherein an angle of the conical-shaped ends is determined such that the lattice network is self-supporting.

31. The component of claim 28, wherein each ascending level has a greater number of lattice elements than a preceding level.

32. The component of claim 28, wherein a density of the lattice elements of each ascending level is lower than a density of the lattice elements of the preceding level.

33. The component of claim 28, wherein a cross-sectional area of the lattice elements of each ascending level is lower than a cross-sectional area of the lattice elements of the preceding level.
